(19) United States
(12) Patent Application Publication
(10) Pub. No.: US 2001/0013203 A1
(43) Pub. Date: Aug. 16, 2001

(54) DEVICE FOR RECOGNITION OF OBSTRUCTION OF CLOSURE

(75) Inventors: PETER GRIESBACH, OSTELSHEIM (DE); HANS GAMERDINGER, WEIL DER STADT (DE); VOLKER PETRI, AIDLINGEN (DE); REINHOLD MICKELER, ALTDORF (DE); MICHEL WITTE, BERTRANGE (LU); ROLAND LORIG, SINSPELT (DE); STEFAN SCHMITT, TRIER (DE)

Correspondence Address: SMITH, GAMBRELL & RUSSELL, LLP, 1850 M STREET, N.W., SUITE 800, WASHINGTON, DC, 20036, US

(73) Assignee: I.V. WEIB

(21) Appl. No.: 09/051,854

(22) PCT Filed: Aug. 19, 1996
(86) PCT No.: PCT/EP96/03585

§ 371 Date: None

(51) Int. Cl. E05F 15/00

(52) U.S. Cl. 49/440; 200/61.43

(57) ABSTRACT

An anti-trapping device is described for a power-operated closing element (4) with a switching element (32) which is arranged along a first closing edge (22) within an elastic hollow section (10), and a power transmitter (16), which abuts against a side area (28) of the hollow section (10) extending longitudinally, so that a trapping force (F) is transmitted to the side area (28) of the hollow section (10). The hollow section comprises a central area (26) extending longitudinally, in which an active area (34) of the switching element (32) is arranged, whereas a non-active edge area of the switching element (32) is arranged in the side area (28). The side area (28) is more deformable on the side of the hollow section facing away from the first closing edge (22) than the central area (26). The force transmitter (16) has at its end abutting against the hollow section a lateral arm (17), which extends to the central area (26) in such a way that the trapping force (F) can be transmitted by the arm (17) to the central area (26).

The invention relates to a device for detection of trapping in a power-operated closing element. Devices of this type are used to switch off the drive unit of the closing element and if necessary reverse its movement in the event of trapping, e.g. of part of the body between two opposite closing edges. These anti-trapping devices are used, for example, on electrically operated window lifters and sliding roofs, automatic vehicle doors, e.g. in buses and trains, as well as in lift doors or the like.

The well-known devices for detection of trapping are based essentially on two different methods of operation.

In a first type of anti-trapping device the information on possible trapping is taken from the power data of the drive unit for the closing element. In the case of electrical drives, for example, this is done by monitoring the motor current or torque output, both of which increase in the event of trapping. If a specific threshold value of the respective parameter is exceeded, the drive motor is switched off and, if necessary, the direction of movement is reversed. Problems are caused in these systems in particular by friction losses of the closing element on guide devices and sealing elements for the closing element. These friction losses are heavily dependent on external factors such as outside temperature or lubrication condition, which leads to wide variation of the monitored drive characteristic values and frequent faulty tripping.

In a second type of anti-trapping device pressure-operated switching elements are used, which are arranged on a closing edge and switch off or reverse the drive unit of the closing element when pressure is applied. LU-A-87 942 describes, for example, an anti-trapping device in which a film pressure sensor is mounted on the closing edge of the closing element. If an obstacle is in the path of movement of the closing element, the film pressure sensor is tripped by direct application of pressure when the obstacle is struck and the drive control of the closing element reverses the direction of movement of the latter.

DE-PS-33 47 945 describes a moulding on the closing edge of a moving closing element, in which a trapping force is transmitted via several segments, some of which are arranged in a V-shape, to a switching rib. The switching rib is forced in the direction of the closing force on to the switching element and trips the latter by direct application of pressure.

The above-mentioned two devices are characterised by an extremely high probability of response, but problems occur when the closing element is closed. In these devices the sealing of the closing element against a closing edge is effected by abutment, i.e. the opposite edges of the switching element and closing edge are pressed against each other to form the seal. The switching element is thus exposed to an inadmissible continuous load, which leads to its destruction after a short time.

DE-PS-196 02 033 describes an anti-trapping device for a closing element in a motor vehicle with an elastic U-shaped sealing section, the legs of which flank the closing element laterally in the closed condition. Each leg is reinforced by a stabilising element extending between the free end of the leg and the hollow chamber. In a case of trapping the reinforced legs of the sealing section guide the trapping force to two longitudinal switching elements, which are arranged in a hollow chamber in the base of the sealing section in such a way that they each lie in the direct range of action of a leg. However, this arrangement of the switching elements in the immediate range of action of the legs proves to be problematical in the case of hard impacts on the sealing section. In fact the position of the switching elements brings about direct transmission of the trapping force to the active area of the switching element, so that hard impacts, as caused in particular by moving obstacles, are transmitted undamped to the switching element and may damage the latter.

Consequently the task of the present invention is to propose a device for detection of trapping which can prevent both inadmissible continuous loading of the switching element when the closing element is closed and also direct and undamped transmission of the trapping force to the switching element.

According to the invention this problem is solved by a device for detection of trapping in a power-operated closing element with a switching element which is arranged along a first closing edge within an elastic hollow section, and a force transmitter extending longitudinally, which is adjacent to a hollow section side area extending longitudinally, so that a trapping force is transmitted to the side area of the hollow section. The hollow section comprises a central area extending longitudinally, in which an active area of the switching element is arranged, whereas a non-active edge area of the switching element is arranged in the side area extending longitudinally. The side area on the side of the hollow section facing away from the first closing edge is more deformable than the central area. On its end facing the hollow section the force transmitter has a lateral arm, which extends to the central area of the hollow section in such a way that the trapping force can be transmitted by the arm to the central area. It should be noted that the first closing edge may belong to a moving closing element and also to a fixed element, which interacts with the closing element when it is closed to close an opening. The side of the hollow section which does not rest against the first closing edge is designated “the side of the hollow section facing away from the first closing edge”. In other words the side of the hollow section facing away from the first closing edge is that side of the hollow section which is visible from the opening to be closed.

The device according to the invention is characterised in that the force transmitter is not arranged directly in the traverse path of the closing element, but eccentrically adjoins a side area of the hollow section. Consequently the closing element can be moved into a closing position, in which the force transmitter extends laterally next to the closing element without the anti-trapping device being tripped, i.e. without application of pressure to the switching element. The closing element can be sealed laterally by the force transmitter, so that an overlapping seal is effected. It should be noted that the active area of the switching element can well be arranged in the extension of the traverse path of the closing element. In this case the switching element lies protected in the space between the closing element and the closing edge when the closing element is closed.

In a case of trapping the closing force of the closing element is conducted by a transverse obstacle to the force transmitter and transmitted by the latter as a trapping force to the side area of the hollow section. The side area is deformed in the direction of the trapping force, so that the force transmitter together with the lateral arm is displaced in the direction of the first closing edge. The arm transmits the displacement to the central area of the hollow section, which consequently exerts pressure on the active area of the switching element and trips the latter. It is self-evident that both the force transmitter and the arm must be less deformable than the side area of the hollow section. For this purpose they are preferably made from the same material as the central area of the hollow section. As this material has a certain flexibility, hard impacts such as may be caused, for example, by moving obstacles are transmitted only in damped form to the switching element. Direct, undamped transmission of the impact to the switching element is consequently effectively prevented, which has a particularly favourable effect on the life of the switching element.

If the closing element is withdrawn from the trapping position, which is effected by reversal of the drive device, the trapping force diminishes and the hollow section resumes its original shape because of its elasticity. Consequently the pressure exerted by the central area of the hollow section on the active area of the switching element diminishes and the switching element opens again.

A further advantage compared to the arrangements described above is that in the device according to the invention the direction of action of the trapping force can be varied over a wide range. Whereas the design of the devices described in the documents cited above means that they can be tripped only if the trapping force is applied essentially at right angles to the switching element, i.e. in the normal direction, the direction of action of the trapping force in the present device may lie in an angular range of about 45° according to the alignment of the force transmitter. If the force transmitter is deflected e.g. by 45° from the normal direction during installation, a vertical component of the trapping force, which is adequate to trip the switching element reliably, is present when the trapping force acts at 45° to the vertical action. This permits particularly flexible use of the present device in different installation positions.

The force transmitter is advantageously connected in one piece to the side area of the hollow section on the side of the hollow section facing away from the first closing edge, and the lateral arm is advantageously connected in one piece to the central area of the hollow section. The force transmitter, the arm and the hollow section thus form a unit, which can be easily manufactured and assembled. The connection point of the force transmitter is preferably selected in such a way that lateral deflection of the free end of the force transmitter does not narrow the hollow space of the hollow section.

To permit particularly accurate transmission of the switching force to the active area of the switching element and thus significantly improve the response behaviour of the device, the central area preferably has a longitudinal elevation, which penetrates into the hollow space of the hollow section, on the side of the hollow section facing away from the first closing edge. The switching force exerted by the central area is then transmitted locally by this elevation to the switching element, so that the switching element is already tripped reliably with a very small deflection of its edge area. As no inadmissibly high point loads should occur, the elevation is preferably rounded with a suitably large radius, whereby good utilisation of the active area of the switching element additionally results.

The higher deformability of the side area in relation to the central area can be achieved, for example, by making the side area from a softer material than the central area. Suitable material selection and suitable dimensioning of the thickness of the side area ensures that the side area can initially be deformed very easily, which ensures high probability of response, but with increasing deformation exerts a greater counter-force and thus limits further deformation. In a preferred embodiment of the hollow section the central area and the side area, however, are made from the same material. In this case the side area has a hollow chamber extending longitudinally, which absorbs the deformation of the side area, on the side of the hollow section facing away from the first closing edge. This embodiment of the hollow section has important advantages with regard to manufacture, because fewer different materials have to be assembled in this case.

In a preferred embodiment of the invention the device comprises a spacer, which in an area of the hollow section on the side of the switching element facing away from the first closing edge extends over the latter's active area. This spacer comprises, for example, an impact buffer made from dimensionally stable material, which extends essentially at right angles to the first closing edge through suitable openings in the hollow section and the switching element, a first end of the impact buffer resting on the first closing edge and a second end of the impact buffer extending beyond the switching element. The second end of the impact buffer may lie within the hollow space of the hollow section or project from the hollow section through a suitable opening in its wall facing away from the first closing edge. This impact buffer prevents a second closing edge, which is opposite the first closing edge when the closing element is closed, from imposing a direct load on the switching element.

In a preferred embodiment the impact buffer comprises a sleeve arranged essentially at right angles to the first closing edge and a rivet, which can be introduced into the sleeve, the inside diameter of the sleeve corresponding essentially to the outside diameter of the rivet shank and the length of the latter being smaller than the depth of the sleeve hole. This two-part design allows the buffer to be assembled particularly easily. In addition an area of the sleeve hole is not filled by the rivet shank after assembly of the impact buffer. If the sleeve is designed with thin walls, this unfilled area of the sleeve imparts a certain flexibility to the impact buffer, so that the closing element is gently braked when the second closing edge strikes the impact buffer. This, of course, has a protective effect on the entire drive mechanism of the closing element on the one hand, and the noise generated when the second closing edge strikes the buffer is clearly reduced on the other.

To prevent direct stressing of the switching element by the second closing edge, the device comprises in an alternative embodiment a spacer in the form of a clamp made from dimensionally stable material, which encloses the hollow section from its side facing away from the first closing edge and is supported by the first closing edge. The clamp is preferably designed in such a way that its shape is adapted to the outer shape of the hollow section with a certain clearance, so that the assembled clamp does not exert any pressure on the hollow section wall facing away from the first closing edge. In order to enclose only the hollow section and not the force transmitter, the clamp is guided laterally through suitable openings in the force transmitter, the openings being designed in such a way that transmission of a trapping force is not impaired. The important advantage of the clamp compared to the impact buffer is that the hollow section need not be drilled when fitting the clamp and the hollow space consequently remains tight. This ensures optimum protection of the switching element arranged in the hollow section against dust and other contaminants. With regard to reduction of noise the clamp is preferably made from an elastic material such as metal or plastic.

In a further advantageous variant the spacer has a first and a second supporting plate, the first supporting plate extending in a longitudinal area of the hallow section over the active area of the switching element and the second supporting plate facing the first one on the opposite side of the switching element. The first and second supporting plates are connected to each other by a segment which extends through the active area of the switching element. This spacer is characterised in particular by extremely small material consumption and particularly easy assembly. Neither the hollow section nor the force transmitter need be modified. The spacer is merely mounted on the switching element and together with the latter pulled into the hollow section. As in the case of the clamp the hollow space remains tight, so that the switching element is protected against dirt.

It should be noted that the use of spacers to avoid direct stressing of the switching element by the closing element is made possible only by the arrangement of the switching element and force transmitter according to the invention. In fact a spacer of this type can be used effectively only if the force transmitter as the tripping element of the device is not arranged directly in the path of the closing element. It should also be noted that all spacers need extend only over a locally limited longitudinal area of the switching element to ensure protection against direct stressing by the closing element. The small longitudinal extension of the spacers then ensures that the response behaviour of the switching element is not impaired and that trapping is reliably detected also in the area of the spacers.

The switching element preferably comprises a film pressure sensor known under the name “force sensing resistor”. Sensors of this type consist of two plastics films glued to each other, spacers being affixed between the films. Electrode paths which mesh with each other in the active area of the sensor are mounted on one of the two films. The second film is coated with a semi-conductor polymer, which establishes an electrical contact between the two meshed electrodes when pressure is applied to the sensor. The higher the pressure applied, the greater the compression of the conductive particles in the polymer and the smaller becomes the resistance of this electrical contact.

Specific embodiments of the invention will now be described below with reference to the enclosed figures. A device for detection of trapping in an electrically operated side window of a motor vehicle is involved.

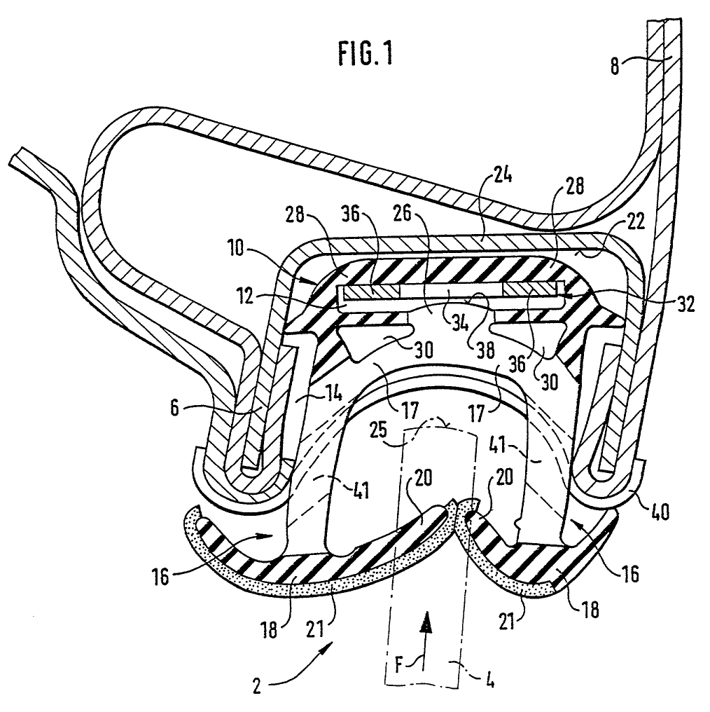

FIG. 1 shows a cross-section through an anti-trapping device with a clamp-type spacer;

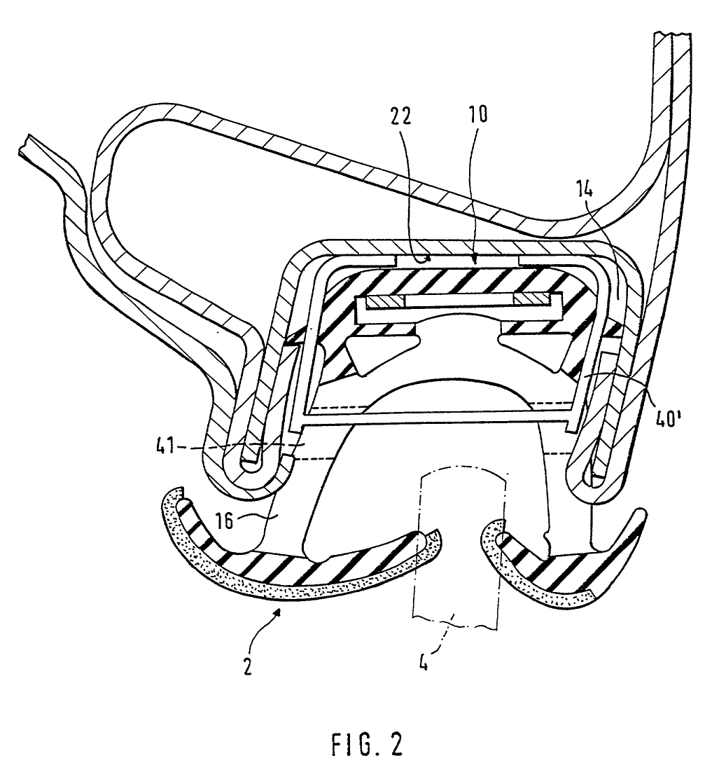

FIG. 2 a cross-section through an anti-trapping device with a second embodiment of a clamp-type spacer;

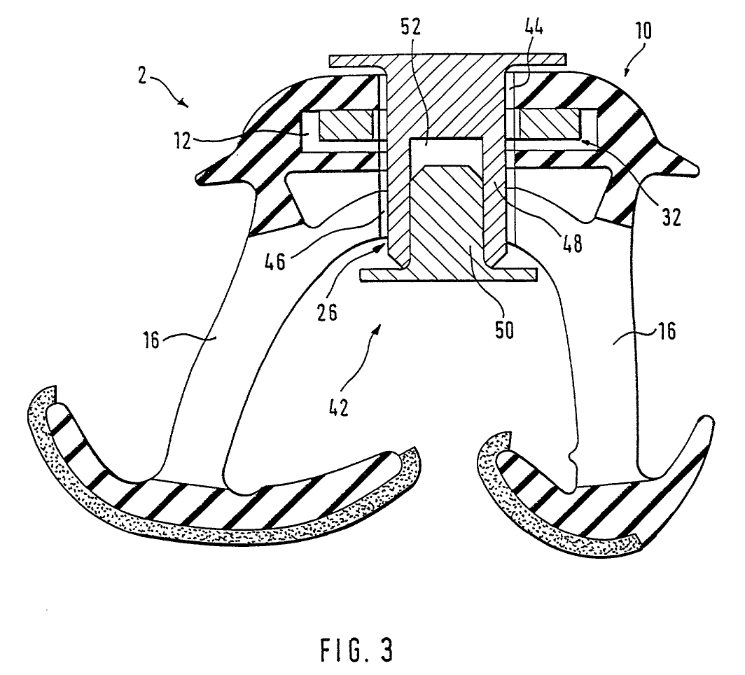

FIG. 3 a cross-section through an anti-trapping device with an impact buffer;

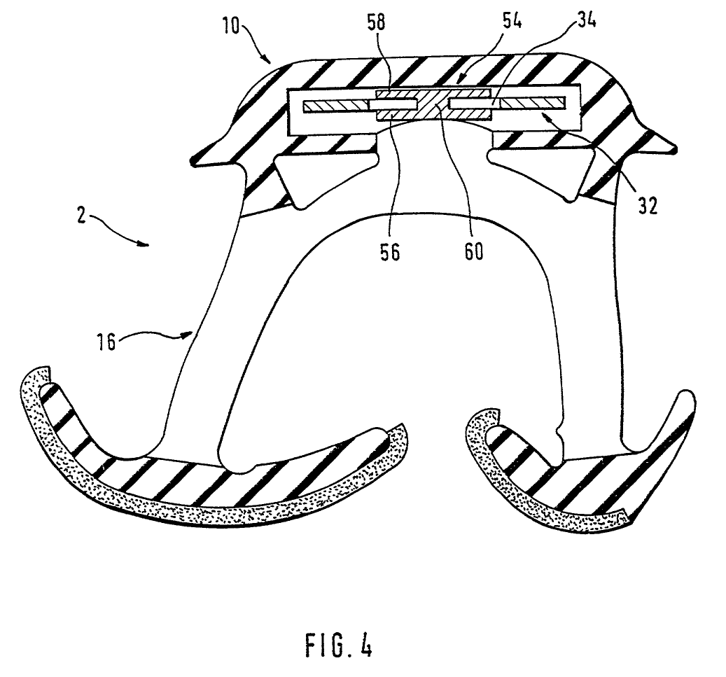

FIG. 4 a cross-section through an anti-trapping device with a further embodiment of a spacer.

The device for detection of trapping described in FIG. 1 is designed as a sealing section 2 for a side window 4 of a motor vehicle and arranged in a profiled window frame 6 in a vehicle door 8. The seal section 2 comprises essentially a hollow section 10 made from elastic material with a hollow space 12, which is protected in a recess 14 in the frame 6, and two legs 16 extending on both sides of the side window 4, which guide and seal the window 4 during closing. The free ends 18 of the two legs 16 also each have a flexible sealing lip 20 on the side facing the window 4, which contact each other when the window 4 is open and thus prevent the penetration of contaminants into the interior of the sealing section 2. When the side window 4 is closed the two sealing lips 20 are forced apart by the window 4, with the result that they rest against the window 4 with a sealing effect because of their elasticity. To prevent generation of noise when the side window 4 slides along, the sealing lips 20 are provided with a flock coating 21 on their side facing the window 4. At their bottom end the legs 16 have a lateral arm 17, which extends to the central area 26 of the hollow section 10, and abuts against the latter. The legs 16, arms 17 and central area 26 of the hollow section 10 are preferably designed so that they merge with each other in one piece.

The hollow section 10 is arranged along a first closing edge 22, which is formed by the base 24 of the recess 14 and is opposite a second closing edge 25 on the side window 4 when the latter is closed. It comprises a central area 26 extending longitudinally (i.e. at right angles to the plane of the drawing) and in each case a side area 28 extending longitudinally. The two side areas 28 of the hollow section are designed in such a way that they are clearly more deformable on the side of the hollow section facing away from the first closing edge 22 than in the central area 26. In the case described this was achieved by construction of a hollow chamber 30, which extends along the entire hollow section 10, in each of the side areas 28. With a force effect at right angles to the closing edge 22 these hollow chambers 30 are compressed, so that the respective side area 28 deforms relatively easily. It should be noted that a higher deformability of the side areas 28 in relation to the central area 26 can also be achieved by manufacturing the side areas 28 from a softer material than the central area 26.

The hollow space 12 of the hollow section 10 extends between the closing edge 22 and the hollow chambers 30 in a transverse direction over the entire central area 26 and laterally into the respective side areas 28, whereas in the longitudinal direction it runs along the entire hollow section. The dimensions of the hollow space 12 are such that a switching element 32, e.g. a film pressure sensor, is held in the hollow space 12 with small lateral and vertical play and is secured against slipping and rotation.

The film pressure sensor 32 is intended to be tripped in the case of trapping in order to switch off a drive mechanism for the side window 4. For this purpose the film pressure sensor 32 comprises an active area 34, which runs centrally along the hollow space 12, and a non-active edge area 36 on each side. In a case of trapping, e.g. if there is an obstacle between the side window 4 and the sealing section 2, the side window 4 cannot be introduced between the two legs 16. The closing force, which is indicated by the arrow F, is consequently transmitted as a trapping force to the legs 16 connected to the respective side area 28 of the hollow section 10, which conduct the trapping force F to the respective side area 28. Each leg 16 thus acts as a force transmitter between an obstacle and the respective side area 28 of the hollow section 10. Consequently the side area 28 of the hollow section 10 in the area of the point of attachment of the leg 16 is deformed in the direction of the trapping force F, with the result that the leg 16 and thus also the arm 17 and the central area 26 are displaced towards the trapping force. The central area 26 is forced against the active area 34 of the film pressure sensor (32) and trips the latter. If the side window 4 is withdrawn from the trapping position, which is effected by reversal of the drive device, the trapping force F diminishes and the hollow section 10 resumes its original shape because of its elasticity. Consequently the pressure exerted by the central area 26 of the hollow section 10 on the active area 34 of the film pressure sensor 32 diminishes and the film pressure sensor 32 opens again. It should be noted that because of the indirect tripping of the film pressure sensor 32 via the lateral arm 17 according to the invention, trapping is reliably detected with a single film pressure sensor 32 even if the trapping occurs at only one of the two legs 16. This is not possible in the case of a device with direct tripping of the switching element, as described above, for example, with reference to DE-PS-195 02 033. In the present device it is consequently unnecessary to use two separate switching elements with an associated complicated connection of these switching elements.

To allow accurate transmission of the trapping force F to the active area 34 of the film pressure sensor 32, the wall of the hollow space 12 facing away from the closing edge 22 preferably has a central elevation 38 extending longitudinally and designed as a switching cam, which projects into the hollow space 12 of the hollow section 10. This switching cam 38 transmits the trapping force exerted by the central area 26 locally to the film pressure sensor 32, so that the latter is already reliably tripped with an extremely small deflection of its edge area 36. As no inadmissibly high point loads are intended to occur in this case, the elevation is preferably rounded with a correspondingly large radius, good utilisation of the active area of the switching element additionally resulting.

A further special feature of the device in FIG. 1 is the spacer 40, which prevents direct stressing of the active area 34 of the film pressure sensor 32 by the window 4. This spacer 40 in the form of a clamp made from dimensionally stable material covers the hollow section on its side facing away from the first closing edge 22 and rests on the side areas of the first closing edge 22. To ensure that the clamp 40 covers only the hollow section 10 and not the legs 16, it is led laterally through corresponding openings 41 in the legs 16. The lateral openings 41 in the legs 16 must be designed in such a way that transmission of a trapping force F, i.e. displacement of the legs 16 in the direction of the force F, is not impeded.

FIG. 2 shows a further embodiment of a clamp-type spacer 40′. The clamp 40′ encloses the hollow section 10 from its side facing away from the first closing edge 22 in order to rest on the first closing edge 22. For this purpose the clamp 40′ advantageously has the shape of the recess 14 in its area facing the closing edge 22. This spacer 40′ is also led laterally through suitable openings 41 into the legs 16, which are designed in such a way that transmission of a trapping force is not impaired. The advantage of this embodiment is that the spacer 40′ can already be assembled around the hollow section 10 before installation of the sealing section 2 in the window frame 6. The sealing section 2 with the spacers 40′ consequently form a unit, which can be assembled together and simplifies subsequent installation in a vehicle door. This is not possible with the spacers 40 in FIG. 1, because these can be assembled only after installation of sealing section 2.

The clamps 40 and 40′ are preferably made from steel sheet, with the result that they have a certain elasticity. When the side window 4 runs against the clamps 40 and 40′ it is consequently braked gently, which protects the drive of the window 4 and counteracts any generation of loud noise.

It should be noted that the clamps 40 and 40′ do not extend over the full length of the hollow section 10, but only locally on a short section. In fact a short spacer 40, 40′ on the full length of the hollow section 10 is generally already adequate for effective prevention of direct loading of the film pressure sensor 32 by the window 4.

An anti-trapping device (not installed) with an impact buffer 42 is shown in FIG. 3. The hollow section 10 and legs 16 are essentially of the same design in this anti-trapping device as in FIGS. 1 and 2. Differences from the section 10 in FIG. 1 result only in the area of an impact buffer 42, which like the clamps 40 and 40′ is arranged only locally at a few points over the length of the hollow section 10. In this area both the central area 26 of the hollow section 10 and the film pressure sensor 32 are provided with a hole 44, which extends essentially at right angles to the first closing edge 22 when the sealing section 2 is installed. The diameter of the hole 44 must be small enough to ensure that the two electrode paths of the film pressure sensor 32 meshed with each other are not fully separated, so that the film pressure sensor 32 in the longitudinal direction on both sides of the hole 44 remains fully serviceable.

An impact buffer 42 made from dimensionally stable material, which rests on the first closing edge 22 and extends essentially at right angles to the latter through the film pressure sensor 32, is introduced into the hole 44 in the hollow section 10 and the film pressure sensor 32. The free end of the impact buffer 42 may lie within the hollow space 12 or project through a suitable opening 46 in the wall of the hollow section 10 facing away from the first closing edge 22.

The impact buffer 42 advantageously comprises a sleeve 48 arranged essentially at right angles to the first closing edge 22 and a rivet 50, which can be introduced into the sleeve 48. The inside diameter of the sleeve corresponds essentially to the outside diameter of the rivet shank, but the length of the latter is smaller than the depth of the sleeve hole. Consequently in the assembled condition a hollow chamber 52 is formed in the sleeve, which imparts a certain flexibility to the impact buffer 42, so that the window 4 is braked gently when the second closing edge 25 strikes the impact buffer 42.

It should be noted that trapping in the area of the impact buffer 42 can be detected despite the hole in the film pressure sensor 32 in this area. In fact a trapping force F striking the legs 16 is transmitted by the legs 16 over a greater length to the side areas 28, so that the resulting deformation of the side areas 28 produces displacement of the central area 26 also in zones which are adjacent to the hole in the longitudinal direction. Consequently reliable tripping of the anti-trapping device is ensured.

A further variant of a spacer 54 is shown in FIG. 4. It has a first 56 and second 58 supporting plate, the first supporting plate 56 extending in a longitudinal area of the hollow section 10 over the active area 34 of the switching element 32. The second supporting plate 58 lies opposite the first supporting plate 56 on the opposite side of the switching element 32. The two supporting plates 56 and 58 are connected to each other by a segment 60, which extends through the active area 34 of the switching element 32. This spacer 54 is characterised above all by extremely low material consumption and particularly simple assembly. Neither the hollow section 10 nor the force transmitter 16 need be modified. The spacer 54 is merely mounted on the film pressure sensor 32 and together with the latter pulled into the hollow section 10. As with the clamps 40 and 40′ the hollow space 12 in the hollow section 10 remains tight, so that the switching element is protected against dirt. The spacer 54 also extends only over a locally limited longitudinal area of the film pressure sensor 32, so that reliable tripping of the anti-trapping device in the case of trapping is still ensured.

1. Device for detection of trapping in a power-operated closing element (4) with a switching element (32), which is arranged along a first closing edge (22) within an elastic hollow section (10), and at least one force transmitter (16) extending longitudinally, which abuts against a side area (28) of the hollow section (10) extending longitudinally, so that a trapping force (F) is transmitted to the side area (28) of the hollow section (10),
characterised in that
the hollow section (10) comprises a central area (26) extending longitudinally, in which an active area (34) of the switching element (32) is arranged,
the side area (28) is more deformable on the side of the hollow section (10) facing away from the first closing edge (22) than the central area (26), and
the force transmitter (16) has at its end abutting against the hollow section (10) a lateral arm (17), which extends to the central area (26) of the hollow section (10) in such a way that the trapping force (F) can be transmitted by the arm (17) to the central area (26).

2. Device according to claim 1, characterised in that the force transmitter (16) on the side of the hollow section (10) facing away from the first closing edge (22) is connected to its side area (28).

3. Device according to claim 1 or 2, characterised in that the lateral arm (17) is connected in one piece to the central area (26) of the hollow section (10), and that the central area (26) on the side of the hollow section (10) facing away from the first closing edge (22) has an elevation (38) extending longitudinally, which projects into the hollow space (12) of the hollow section (10).

4. Device according to one of the preceding claims, characterised in that the side area (28) on the side of the hollow section (10) facing away from the first closing edge (22) has a hollow chamber (30) extending longitudinally.

5. Device according to one of the preceding claims, characterised by a spacer (40, 40′, 42, 54), which extends in an area of the hollow section (10) on the side of the switching element (32) facing away from the first closing edge (22) over its active area (34).

6. Device according to claim 5, characterised in that the spacer comprises an impact buffer (42) made from dimensionally stable material, which extends essentially at right angles to the first closing edge (22) through suitable openings (44) in the hollow section (10) and the switching element (32), a first end of the impact buffer (42) resting on the first closing edge (22) and a second end of the impact buffer (42) extending beyond the switching element (32).

7. Device according to claim 6, characterised in that the impact buffer (42) comprises a sleeve (48) arranged essentially at right angles to the first closing edge (22) and a rivet (50), which can be introduced into the sleeve (48), the inside diameter of the sleeve (48) corresponding essentially to the outside diameter of the rivet shank and the length of the rivet shank being smaller than the depth of the sleeve hole.

8. Device according to claim 5, characterised in that the spacer comprises a clamp (40, 40′) made from dimensionally stable material, which encloses the hollow section (10) from its side facing away from the first closing edge (22) and rests on the first closing edge (22).

9. Device according to claim 8, characterised in that the clamp (40, 40′) consists of an elastic material.

10. Device according to claim 5, characterised in that the spacer has a first and a second supporting plate (56 and 58), the first supporting plate (56) extending in a longitudinal area of the hollow section (10) over the active area (34) of the switching element (32) and the second supporting plate (58) being opposite the first supporting plate (56) on the opposite side of the switching element (32), and that the first and second supporting plates (56 and 58) are connected to each other by a segment (60), which extends through the active area (34) of the switching element (32).

11. Device according to one of the preceding claims, characterised in that the switching element (32) comprises a film pressure sensor.
